(19) United States
(12) Patent Application Publication
(10) Pub. No.: US 2025/0148772 A1
(43) Pub. Date: May 8, 2025

(54) NEURAL NETWORK POINT CLOUD DATA ANALYZING METHOD AND COMPUTER PROGRAM PRODUCT

(71) Applicant: NATIONAL CHANGHUA UNIVERSITY OF EDUCATION, CHANGHUA CITY (TW)

(72) Inventors: Shih-Lin LIN, CHANGHUA CITY (TW); Jun-Yi WU, CHANGHUA CITY (TW)

(21) Appl. No.: 18/931,102

(22) Filed: Oct. 30, 2024

(30) Foreign Application Priority Data
Nov. 3, 2023 (TW) 112142509

(51) Int. Cl. G06V 10/82; G06V 20/58

(52) U.S. Cl. CPC G06V 10/82; G06V 20/58

(57) ABSTRACT

A neural network point cloud data analyzing method includes a data input step and an analyzing step. In the data input step, a processor receives a point cloud data. In the analyzing step, the processor analyzes the point cloud data based on an enhanced VoxNet 3D model. The enhanced VoxNet 3D model includes an input layer, a first hidden unit, a first pooling layer, a 1st to a 3rd second hidden units, a second pooling layer, a third pooling layer and a fourth pooling layer. The input layer is for inputting the point cloud data. The first hidden unit is signally connected to the input layer. The first pooling layer receives an output from a first activation layer. The 1st to the 3rd second hidden units are sequentially connected after the first pooling layer.

### RELATED APPLICATIONS

This application claims priority to Taiwan Application Serial Number 112142509, filed Nov. 3, 2023, which is herein incorporated by reference.

### BACKGROUND

### Technical Field

The present disclosure relates to a point cloud dada analyzing method and a computer program product. More particularly, the present disclosure relates to a neural network point cloud dada analyzing method and a computer program product.

### Description of Related Art

Recently, autonomous vehicles and unmanned vehicles are developed quickly. With analyzation and classification based on sensors detecting the environment, a purpose of self-driving can be achieved. The sensors may for example be cameras or lidars, and the lidar generates point cloud data. The point cloud data is sparse, noisy, and unstructured; therefore, it is hard to analyze the point cloud data.

Deep learning algorithms may solve the problems that the point cloud data of the lidar is sparse, noisy, and unstructured. However, the conventional 3D neural network algorithms still have some limitations such as a poor performance and low accuracy. In addition, although some practitioners conduct feature padding for the point cloud data to lower the fitting problems, but the process is complex, and there is a requirement to be improved.

Based on the above problems, how to increase the actuary of classification based on analyzing the point cloud data of the lidar becomes a target that those in the filed peruse.

### SUMMARY

According to one aspect of the present disclosure, a neural network point cloud data analyzing method includes a data input step and an analyzing step. In the data input step, a processor receives a point cloud data. In the analyzing step, the processor analyzes the point cloud data based on an enhanced VoxNet 3D model. The enhanced VoxNet 3D model includes an input layer, a first hidden unit, a first pooling layer, a 1st to a 3rd second hidden units, a second pooling layer, a third pooling layer and a fourth pooling layer. The input layer is for inputting the point cloud data. The first hidden unit is signally connected to the input layer and includes a first convolution layer, a first batch-normalization layer and a first activation layer in order. The first pooling layer receives an output from the first activation layer. The 1st to the 3rd second hidden units are sequentially connected after the first pooling layer, each of the 1st to the 3rd second hidden units includes a second convolution layer, a second batch-normalization layer, a second activation layer, a third convolution layer, a third batch-normalization layer, an adding layer and a third activation layer in order, and the adding layer receives and summarizes an output from the second batch-normalization layer and an output from the third batch-normalization layer. The second pooling layer is connected between the third activation layer of the 1st second hidden unit and the second convolution layer of a 2nd second hidden unit of the 1st to the 3rd second hidden units. The third pooling layer is connected between the third activation layer of the 2nd second hidden unit and the second convolution layer of the 3rd second hidden unit. The fourth pooling layer is connected after the third activation layer of the 3rd second hidden unit.

According to another aspect of the present disclosure, a computer program product which is applied for a processor to conduct receiving a point cloud data and analyzing the point cloud data based on an enhanced VoxNet 3D model. The enhanced VoxNet 3D model includes an input layer, a first hidden unit, a first pooling layer, a 1st to a 3rd second hidden units, a second pooling layer, a third pooling layer and a fourth pooling layer. The input layer is for inputting the point cloud data. The first hidden unit is signally connected to the input layer and includes a first convolution layer, a first batch-normalization layer and a first activation layer in order. The first pooling layer receives an output from the first activation layer. The 1st to the 3rd second hidden units are sequentially connected after the first pooling layer, each of the 1st to the 3rd second hidden units includes a second convolution layer, a second batch-normalization layer, a second activation layer, a third convolution layer, a third batch-normalization layer, an adding layer and a third activation layer in order, and the adding layer receives and summarizes an output from the second batch-normalization layer and an output from the third batch-normalization layer. The second pooling layer is connected between the third activation layer of the 1st second hidden unit and the second convolution layer of a 2nd second hidden unit of the 1st to the 3rd second hidden units. The third pooling layer is connected between the third activation layer of the 2nd second hidden unit and the second convolution layer of the 3rd second hidden unit. The fourth pooling layer is connected after the third activation layer of the 3rd second hidden unit.

### BRIEF DESCRIPTION OF THE DRAWINGS

The present disclosure can be more fully understood by reading the following detailed description of the embodiment, with reference made to the accompanying drawings as follows:

FIG. 1 is a block flow char of a neural network point cloud data analyzing method according to one embodiment of the present disclosure.

FIG. 2A is one schematic view of an enhanced VoxNet 3D model of the neural network point cloud data analyzing method of FIG. 1.

FIG. 2B is another schematic view of the enhanced VoxNet 3D model of the neural network point cloud data analyzing method of FIG. 1.

### DETAILED DESCRIPTION

The embodiments of the present disclosure will be illustrated with drawings hereinafter. In order to clearly describe the content, many practical details will be mentioned with the description hereinafter. However, it will be understood by the reader that the practical details will not limit the present disclosure. In other words, in some embodiment of the present disclosure, the practical details are not necessary. Additionally, in order to simplify the drawings, some conventional structures and elements will be illustrated in the drawings in a simple way; the repeated elements may be labeled by the same or similar reference numerals.

In addition, the terms first, second, third, etc. are used herein to describe various elements or components, these elements or components should not be limited by these terms. Consequently, a first element or component discussed below could be termed a second element or component. Moreover, the combinations of the elements, the components, the mechanisms and the modules are not well-known, ordinary or conventional combinations, and whether the combinations can be easily completed by the one skilled in the art cannot be judged based on whether the elements, the components, the mechanisms or the module themselves are well-known, ordinary or conventional.

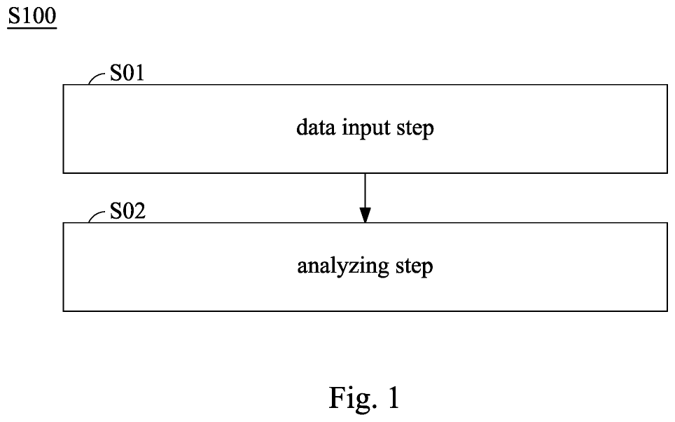

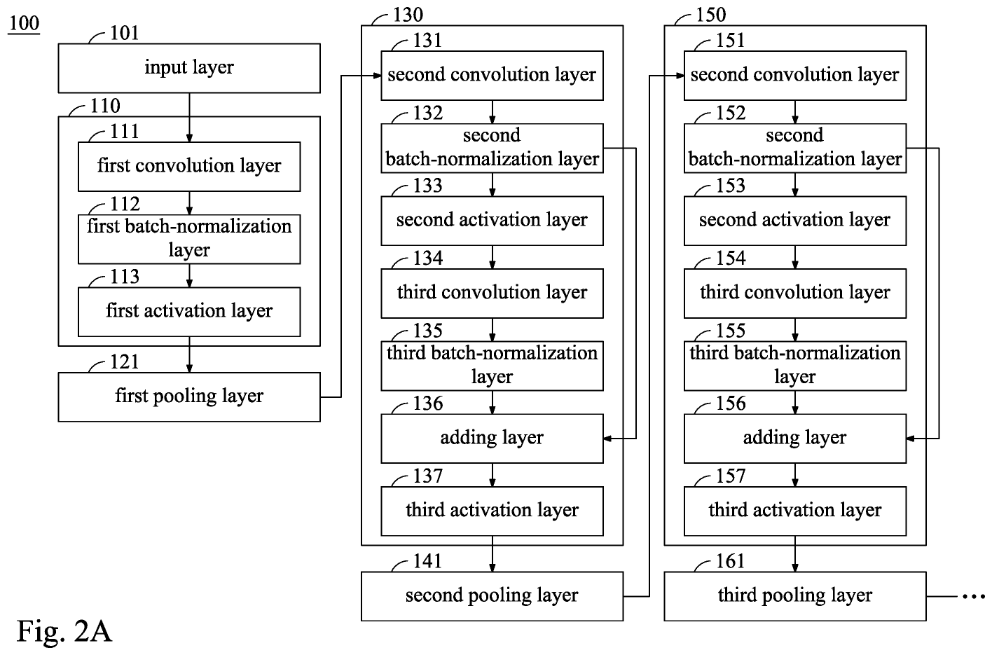

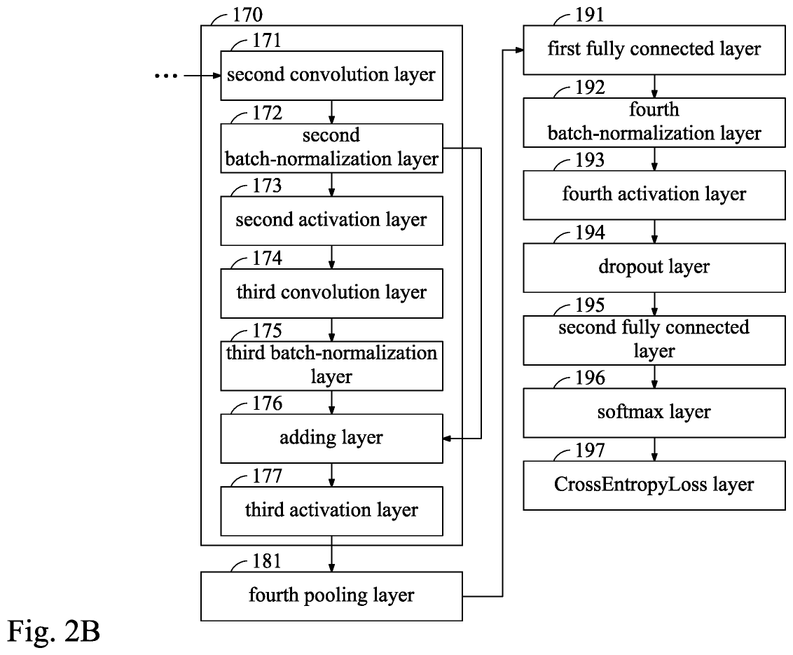

FIG. 1 is a block flow char of a neural network point cloud data analyzing method S100 according to one embodiment of the present disclosure. FIG. 2A is one schematic view of an enhanced VoxNet 3D model 100 of the neural network point cloud data analyzing method S100 of FIG. 1. FIG. 2B is another schematic view of the enhanced VoxNet 3D model 100 of the neural network point cloud data analyzing method S100 of FIG. 1. The neural network point cloud data analyzing method S100 includes a data input step S01 and an analyzing step S02.

In the data input step S01, a processor receives a point cloud data.

In the analyzing step S02, the processor analyzes the point cloud data based on the enhanced VoxNet 3D model 100. The enhanced VoxNet 3D model 100 includes an input layer 101, a first hidden unit 110, a first pooling layer 121, a 1st to a 3rd second hidden units 130, 150, 170, a second pooling layer 141, a third pooling layer 161 and a fourth pooling layer 181. The input layer 101 is for inputting the point cloud data. The first hidden unit 110 is signally connected to the input layer 101 and includes a first convolution layer 111, a first batch-normalization layer 112 and a first activation layer 113 in order. The first pooling layer 121 receives an output from the first activation layer 113.

The 1st to the 3rd second hidden units 130, 150, 170 are sequentially connected after the first pooling layer 121, each of the 1st to the 3rd second hidden units 130, 150, 170 includes a second convolution layer 131, 151, 171, a second batch-normalization layer 132, 152, 172, a second activation layer 133, 153, 173, a third convolution layer 134, 154, 174, a third batch-normalization layer 135, 155, 175, an adding layer 136, 156, 176 and a third activation layer 137, 157, 177 in order, and the adding layer 136, 156, 176 receives and summarizes an output from the second batch-normalization layer 132, 152, 172 and an output from the third batch-normalization layer 135, 155, 175. The second pooling layer 141 is connected between the third activation layer 137 of the 1st second hidden unit 130 and the second convolution layer 151 of a 2nd second hidden unit 150 of the 1st to the 3rd second hidden units 130, 150, 170. The third pooling layer 161 is connected between the third activation layer 157 of the 2nd second hidden unit 150 and the second convolution layer 171 of the 3rd second hidden unit 170. The fourth pooling layer 181 is connected after the third activation layer 177 of the 3rd second hidden unit 170.

Therefore, with the first batch-normalization layer 112, the second batch-normalization layers 132, 152, 172 and the third batch-normalization layers 135, 155, 175, the neural network is more stable and reliable. Moreover, the converging speed is increased, the overfitting risk is reduced, and the representation capability is improved. Furthermore, the vanishing gradient problem may be solved by the residual structure. With the enhanced representation capability to capture features that are more complex, the generalization ability and accuracy of the enhanced VoxNet 3D model 100 are increased. In addition, since the enhanced VoxNet 3D model 100 has the ability to increase the accuracy, there is no need to process the point cloud data in advance, and the complex of the process is reduced. Details of the neural network point cloud data analyzing method S100 will be described hereinafter.

The processor may for example be a central processing unit (CPU), a digital signal processor (DSP), a microprocessor unit (MPU) or a microcontroller unit (MCU). The processor is programmable for achieving specific functions. In one embodiment, the point cloud data may be generated by the lidar on a vehicle, and the processer may be the processor on the vehicle, but the present disclosure is not limited thereto.

After the processer receives the point cloud data, voxelization of the point cloud data may be conducted first, and then the point cloud data is analyzed by the enhanced VoxNet 3D model 100. The enhanced VoxNet 3D model 100 may be constructed and trained in advance to classify objects such as cars, pedestrians and trees. In the enhanced VoxNet 3D model 100, a number of convolution kernels in each of the first convolution layer 111, and the second convolution layer 131 and the third convolution layer 134 of the 1st second hidden unit 130 is 32. A number of convolution kernels in each of the second convolution layer 151 and the third convolution layer 154 of the 2nd second hidden unit 150 is 64. A number of convolution kernels in each of the second convolution layer 171 and the third convolution layer 174 of the 3rd second hidden unit 170 is 128.

Specifically, as shown in FIG. 2A, the point cloud data may be input into the input layer 101 and then be input into the first pooling layer 121 after processing by the first convolution layer 111, the first batch-normalization layer 112 and the first activation layer 113 of the first hidden unit 110. A size of the volumetric data of the input layer 101 is for example 32. The number of the convolution kernels of the first convolution layer 111 is 32, a size of the each of the convolution kernels is 3 and a stride is 1. With extracting the volumetric features from the input by the 32 convolution kernels, the size of the volumetric features is preserved. After which, the size of the volumetric features is reduced by the first pooling layer 121, and the most importance features are extracted. An output size of the first pooling layer 121 may be 16, the size of the filter is 2, the stride is 2 and the padding is 0.

After which, an output from the first pooling layer 121 may be input into the second convolution layer 131 of the 1st second hidden unit 130, and then is processed by the second batch-normalization layer 132, the second activation layer 133, the third convolution layer 134 and the third batch-normalization layer 135 in order. The output from the second batch-normalization layer 132 may be input into the adding layer 136 to be combined with the output from the third batch-normalization layer 135. After which, the output of the adding layer 136 may be input into the third activation layer 137, and the output of the third activation layer 137 is input into the second pooling layer 141. An output size of the second convolution layer 131 and an output size of the third convolution layer 134 are both 14, a size of each of convolution kernels is 3, a number of the convolution kernels is 32, and the stride is 2. The padding of the second convolution layer 131 is 0 and the padding of the third convolution layer 134 is 1. In order to increase the depth of the model and the representation capability while preventing the vanishing gradient problem, the volumetric features from the front layer is directly connected to the next layer, that is, adding the output of the second batch-normalization layer 132 to the output of the third batch-normalization layer 135, thereby increasing the nonlinear expression ability of the model. An output size of the second pooling layer 141 may be 7, the size of the filter is 2, the stride is 2 and the padding is 0. Hence, the size of the volumetric features is reduced again and the most important features are extracted.

Subsequently, the output of the second pooling layer 141 may be input into the second convolution layer 151 of the 2nd second hidden unit 150, and then is processed by the second batch-normalization layer 152, the second activation layer 153, the third convolution layer 154 and the third batch-normalization layer 155 in order. The output from the second batch-normalization layer 152 may be input into the adding layer 156 to be combined with the output from the third batch-normalization layer 155. After which, the output of the adding layer 156 may be input into the third activation layer 157, and the output of the third activation layer 157 is input into the third pooling layer 161. An output size of the second convolution layer 151 is 8, a size of each of convolution kernels is 2, the stride is 2, the padding is 1, and a number of the convolution kernels is increased to 64 to increase the size of the volumetric features. A size of each of convolution kernels of the third convolution layer 154 is 3, the stride is 2, the padding is 1, and a number of the convolution kernels is 64. An output size of the third pooling layer 161 may be 4, the size of the filter is 2, the stride is 2 and the padding is 0.

The output of the second pooling layer 141 may be input into the second convolution layer 171 of the 3rd second hidden unit 170, and then is processed by the second batch-normalization layer 172, the second activation layer 173, the third convolution layer 174, the third batch-normalization layer 175, the adding layer 176 and the third activation layer 177 in order. The output from the third batch-normalization layer 175 may be input into the adding layer 176, and the second batch-normalization layer 172 may be also input into the adding layer 176 to be combined with the output from the third batch-normalization layer 175. After which, the output of the adding layer 176 may be input into the third activation layer 177, and the output of the third activation layer 177 is input into the fourth pooling layer 181. An output size of the second convolution layer 171 is 3, a size of each of convolution kernels is 2, the stride is 1, the padding is 0, and a number of the convolution kernels is increased to 128 to increase the size of the volumetric features. A number of convolution kernels of the third convolution layer 174 is 128, a size of each of the convolution kernels of is 3, the stride is 1, and the padding is 1. The output size of the fourth pooling layer 181 may be 1, the size of the filter is 2, the stride is 2 and the padding is 0. Therefore, the size of the volumetric features is reduced to 1 for the final classification or regression. It is noted that, in the present disclosure, the term “size” represents width×height×channel of the input data.

In other words, the output size of the second pooling layer 141 is smaller than the output size of the first pooling layer 121, the output size of the third pooling layer 161 is smaller than the output size of the second pooling layer 141, and the output size of the fourth pooling layer 181 is smaller than the output size of the third pooling layer 161 and is equal to 1. Each of the first pooling layer 121, the second pooling layer 141, the third pooling layer 161 and the fourth pooling layer 181 is a maximum pooling layer which can reduce the size of volumetric features, lower the calculation volumes and increase the calculation speed of the model. Meanwhile, the maximum pooling layer facilitates for extracting the important features of the volumetric features, and the performance of the model is increased.

Each of the first activation layer 113, the second activation layers 133, 153, 173 and the third activation layers 137, 157, 177 uses a ReLU activation function, and a ratio thereof is set to 0.01. More preferably, the ReLU activation function is a LeakyReLU activation function, which facilitates for increasing the nonlinear expression ability. In the present disclosure, each convolution layer is followed by a batch-normalization layer and an activation layer. The batch-normalization layer conducts normalization for the input data, thereby increasing the converging speed and the training effect of the neural network. The activation layer, especially with the LeakyReLU activation function, can output a certain non-zero value in the negative region, which helps to alleviate the issue of neuron death. In the residual connection, the output and residuals are directly added together, the output is more stable, oscillation during training is reduced, and the accuracy is improved. Finally, with the 32, 64, and 128 convolution kernels used in the convolutional layers, the nonlinear expression ability of the neural network is increased, thereby better fitting complex features.

The enhanced VoxNet 3D model 100 may further include a first fully connected layer 191, a fourth batch-normalization layer 192, a fourth activation layer 193, and a dropout layer 194 connected after the fourth pooling layer 181 in order. Moreover, the enhanced VoxNet 3D model 100 may further include a second fully connected layer 195, a softmax layer 196 and a CrossEntropyLoss layer 197 connected after the dropout layer 194 in order. The ratio of the dropout layer 194 may be set to 0.5 to shut off 50% of the neurons during the training process. Therefore, with the aforementioned configuration, the enhanced VoxNet 3D model 100 may classify the point cloud data.

The present disclosure provide another embodiment, a computer program product which is applied for a processor to conduct receiving a point cloud data and analyzing the point cloud data based on an enhanced VoxNet 3D model. The computer program product may be an object containing a readable program without being limited by the external appearance. The computer program product may be any data storage hardware unit, e.g., a memory device, for storing data which may be read by a computer device. A Non-transitory computer readable media may be a hard disc, a network attached storage (NAS), a read-only memory (ROM), a random-access memory (RAM), a CD-ROM, a CD-R, a CD-RW, a tape and other optical or non-optical storage hardware units. Therefore, the computer program may be read and executed. The details of the enhanced VoxNet 3D model 100 are as aforementioned and will not be repeated.

### Examples

A lidar such as Velodyne VLP-16 is disposed at a vehicle. The lidar may use the laser emitter to emit laser light outward, and may receive the reflection laser light for sensing the environment. The data from the lidar may be processed by a software such as VeloView 5.1.0, and the point cloud data including distances, reflection strength and angles captured in real time may be shown.

The enhanced VoxNet 3D model may be constructed by Deep Network Designer. As training the enhanced VoxNet 3D model, a point cloud database may be constructed in Matlab based collected data including four three-dimensional point cloud data from common objects such as a car, a biker, a pedestrian and a tree, and the enhanced VoxNet three-dimensional model may be trained by the 3D point cloud data.

As evaluating the performance of the enhanced VoxNet 3D model, a confusion matrix may be used to calculate the accuracy, the recall rate, and the F1 score. The confusion matrix includes four important numbers: true positives (TP), false negatives (FN), false Positives (FP) and true negatives (TN). TP represents a number of samples being predicted to be positive and the actual value being also positive. FN represents a number of samples being predicted to be negative and the actual value being positive. FP represents a number of samples being predicted to be positive and the actual value being negative. TN represents a number of samples being predicted to be negative and the actual value being also negative.

A comparison example uses a conventional VoxNet 3D model, the trained batch size is 64, and the conventional VoxNet 3D model is trained by an adaptive moment estimation. The conventional VoxNet 3D model includes an input layer, a first and a second hidden units each including a convolution layer and an activation layer, a pooing layer, a first fully connected layer, an activation layer, a dropout layer, a second fully connected layer, a softmax layer and a CrossEntropyLoss layer in order. A number of the layers is 12. The input size is 32. The size of convolution kernel of the first hidden unit is 5, the stride is 2 and the padding is 0. The size of convolution kernel of the second hidden unit is 3, the stride is 2 and the padding is 0. The size of convolution kernel of the pooling layer is 2, the stride is 2 and the padding is 0. In the first fully connected layer, a number of convolution kernels increases to 128. The ratio of the dropout layer is set to 0.5. An experimental example uses the enhanced VoxNet 3D model provided by the present disclosure, and a number of the layers are 36 as shown in FIGS. 2A and 2B. The batch size is 64, and the enhanced VoxNet 3D model is also trained by the adaptive moment estimation.

Each of the comparison example and the experimental example is trained by 60 cars, 60 bikers, 60 pedestrians and 60 trees. 60 cars, 60 bikers, 60 pedestrians and 60 trees are used to test the comparison example and the experimental example. For the comparison example, 59 cars are classified correctly, 1 car is classified incorrectly and is classified as a biker, which is FN, and the recall rate is 98.3%. 1 non-car is classified as car, which is FP, and the precision is 98.3%. 55 bikers are classified correctly, 5 bikers are classified incorrectly because 4 bikers are classified as pedestrians and 1 biker is classified as a car, which are FN, and the recall rate is 91.7%. 6 non-bikers are classified as bikers, which are FP, and the precision is 90.2%. 54 pedestrians are classified correctly, 6 pedestrians are classified as 5 bikers and 1 tree, which are FN, and the recall rate is 90.0%. 8 non-pedestrians are classified as pedestrian, which are FP, and the precision is 87.1%. 56 trees are classified correctly, 4 trees are classified as pedestrians, which are FN, and the recall rate is 93.3%. 1 non-tree is classified as a tree, and the precision is 98.2%. Therefore, the total accuracy of the confusion matrix of the conventional VoxNet 3D model of the comparison example is 93.3%.

For the experimental example, 60 cars are classified correctly, 0 car is classified as other objects, which is FN, and the recall rate is 100%. 0 non-car is classified as a car, which is FP, and the precision is 100%, 60 bikers are classified correctly, 0 biker is classified as other objects, which is FN, and the recall rate is 100%. 4 non-bikers are classified as bikers, which are FP, and the precision is 93.3%. 56 pedestrians are classified correctly, 4 pedestrians are classified as bikers, which are FN, and the recall rate is 93.3%. 1 non-pedestrian is classified as a pedestrian, which is FP, and the precision is 98.2%. 59 trees are classified correctly, 1 tree is classified as a pedestrian, which is FN, and the recall rate is 98.3%. 0 non-tree is classified as a tree, and the precision is 100%. Therefore, the total accuracy of the confusion matrix of the enhanced VoxNet 3D model of the experimental example is 97.9%, which is higher than the 93.3% of the comparison example.

Table 1 shows performance indicators of the comparison example and the experimental example. As shown in Table 1, the experimental example not only has high accuracy, but the loss of 0.10 is also lower than the loss of 0.19 of the comparison example.

TABLE 1

| | training time | | |
|---|---|---|---|
| | (min:sec) | accuracy (%) | loss |
| comparison | 2:17 | 93.3 | 0.19 |
| example | | | |
| experimental | 3:42 | 97.9 | 0.10 |
| example | | | |

It is known from the above embodiments and the experimental example, with the architecture and layers of the enhanced VoxNet 3D model, and the modification of hyperparameter, the accuracy of analyzing complex data and low data volumes is increased. Moreover, in addition to enhance the learning capability of the neural network, the risk of generating vanishing gradient problem is decreased. Moreover, a number of neurons required is lowered, and the generalization ability is improved to process complex datasets.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A neural network point cloud data analyzing method, comprising:
a data input step, wherein a processor receives a point cloud data; and
an analyzing step, wherein the processor analyzes the point cloud data based on an enhanced VoxNet 3D model, and the enhanced VoxNet 3D model comprises:
an input layer for inputting the point cloud data;
a first hidden unit signally connected to the input layer and comprising a first convolution layer, a first batch-normalization layer and a first activation layer in order;
a first pooling layer receiving an output from the first activation layer;
a 1st to a 3rd second hidden units sequentially connected after the first pooling layer, each of the 1st to the 3rd second hidden units comprising a second convolution layer, a second batch-normalization layer, a second activation layer, a third convolution layer, a third batch-normalization layer, an adding layer and a third activation layer in order, wherein the adding layer receives and summarizes an output from the second batch-normalization layer and an output from the third batch-normalization layer;
a second pooling layer connected between the third activation layer of the 1 st second hidden unit and the second convolution layer of a 2nd second hidden unit of the 1st to the 3rd second hidden units;
a third pooling layer connected between the third activation layer of the 2nd second hidden unit and the second convolution layer of the 3rd second hidden unit; and
a fourth pooling layer connected after the third activation layer of the 3rd second hidden unit.

2. The neural network point cloud data analyzing method of claim 1, wherein the enhanced VoxNet 3D model further comprises a first fully connected layer, a fourth batch-normalization layer, a fourth activation layer, and a dropout layer connected after the fourth pooling layer in order.

3. The neural network point cloud data analyzing method of claim 2, wherein the enhanced VoxNet 3D model further comprises a second fully connected layer, a softmax layer and a CrossEntropyLoss layer connected after the dropout layer in order.

4. The neural network point cloud data analyzing method of claim 3, wherein an output size of the second pooling layer is smaller than an output size of the first pooling layer, an output size of the third pooling layer is smaller than the output size of the second pooling layer, and an output size of the fourth pooling layer is smaller than the output size of the third pooling layer and is equal to 1.

5. The neural network point cloud data analyzing method of claim 1, wherein each of the first activation layer, the second activation layer and the third activation layer uses a ReLU activation function, and a ratio thereof is set to 0.01.

6. The neural network point cloud data analyzing method of claim 1, wherein a number of convolution kernels of the first convolution layer, a number of convolution kernels of the second convolution layer of the 1st second hidden unit, and a number of convolution kernels of the third convolution layer of the 1st second hidden unit are all 32, wherein a number of convolution kernels of the second convolution layer of the 2nd second hidden unit and a number of convolution kernels of the third convolution layer of the 2nd second hidden unit are all 64, wherein a number of convolution kernels of the second convolution layer of the 3rd second hidden unit and a number of convolution kernels of the third convolution layer of the 3rd second hidden unit are all 128.

7. A computer program product, being applied for a processor to conduct:
receiving a point cloud data; and
analyzing the point cloud data based on an enhanced VoxNet 3D model, the enhanced VoxNet 3D model comprising:
an input layer for inputting the point cloud data;
a first hidden unit signally connected to the input layer and comprising a first convolution layer, a first batch-normalization layer and a first activation layer in order;
a first pooling layer receiving an output from the first activation layer;
a 1st to a 3rd second hidden units sequentially connected after the first pooling layer, each of the 1st to the 3rd second hidden units comprising a second convolution layer, a second batch-normalization layer, a second activation layer, a third convolution layer, a third batch-normalization layer, an adding layer and a third activation layer in order, wherein the adding layer receives and summarizes an output from the second batch-normalization layer and an output from the third batch-normalization layer;
a second pooling layer connected between the third activation layer of the 1st second hidden unit and the second convolution layer of a 2nd second hidden unit of the 1st to the 3rd second hidden units;
a third pooling layer connected between the third activation layer of the 2nd second hidden unit and the second convolution layer of the 3rd second hidden unit; and
a fourth pooling layer connected after the third activation layer of the 3rd second hidden unit.

8. The computer program product of claim 7, wherein the enhanced VoxNet 3D model further comprises a first fully connected layer, a fourth batch-normalization layer, a fourth activation layer, a dropout layer, a second fully connected layer, a softmax layer and a CrossEntropyLoss layer connected after the fourth pooling layer in order.

9. The computer program product of claim 7, wherein each of the first pooling layer, the second pooling layer, the third pooling layer and the fourth pooling layer is a maximum pooling layer.

10. The computer program product of claim 7, wherein each of the first activation layer, the second activation layer and the third activation layer uses ReLU activation function, and a ratio thereof is set to 0.01.
